(19) United States
(12) Patent Application Publication
(10) Pub. No.: US 2013/0254001 A1
(43) Pub. Date: Sep. 26, 2013

(54) CONVERTING A DIGITAL MEDIA ITEM FROM A RENTAL TO A PURCHASE

(71) Applicants: Gündüzhan Acar, Hutto, TX (US); Yoko Nodera, Austin, TX (US)

(72) Inventors: Gündüzhan Acar, Hutto, TX (US); Yoko Nodera, Austin, TX (US)

(73) Assignee: Apple Inc., Cupertino, CA (US)

(21) Appl. No.: 13/430,402

(22) Filed: Mar. 26, 2012

(51) Int. Cl. G06Q 30/06; G06Q 30/02

(52) U.S. Cl. 705/14.23; 705/27.1

(57) ABSTRACT

Consumer satisfaction and revenue both have the potential to increase through the conversion of a digital media item from a rental to a purchase. After the rental of a digital media item, the occurrence of a predefined event can trigger the display of a conversion opportunity on a client device. The predefined event can include identifying that the digital media item has previously been rented, detecting that the digital media item has been paused or playback has reached a predefined point, or detecting the expiration of the rental period. In some cases, the digital media item can be offered for purchase at a discounted rate based on the rental history or in a different level of quality.

### BACKGROUND

1. Technical Field

The present disclosure relates to the purchase of a digital media item rental and more specifically to the conversion of a digital media item from a rental to a purchase.

2. Introduction

Many media items such as movies or television shows are available digitally to rent or purchase. When presented with the option to rent or buy a particular media item, a consumer generally weighs a number of factors, which can include the level of familiarity with the media item and the previous rental history. If the consumer has limited familiarity with the media item, the consumer may be unsure if he or she will enjoy the item enough to use it again in the future, and thus the consumer may be more likely to rent rather than buy the media item. However, after renting the media item some consumers have remorse and wish they had purchased the media item instead. Unfortunately, many consumers with rental remorse do not end up purchasing the media item because they are unwilling to pay the full purchase price after having already paid to rent the item.

Additionally, some consumers when presented with the dilemma of renting versus purchasing choose neither option because their desire to not waste money outweighs their desire to experience the media item. In some cases, the choice to forgo is temporary while the consumer gathers more information. However, for others the desire to experience the media item passes without the consumer either renting or purchasing. Each of these scenarios potentially results in lost revenue for the media item provider and a lack of satisfaction for the consumer.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present disclosure describes systems, methods, and non-transitory computer readable media for converting a digital media item from a rental to a purchase. A first method includes receiving a request to rent a digital media item, such as a movie or television show. The rental request can include a user account identifier and a media item identifier, as well as a variety of other information, such as level of quality, client device identifier, etc. In response to the request, the method can include updating the user account associated with the user account identifier to include a rental token. The rental token can be associated with a rental period and/or use policy for the requested digital media item. At some point, the method can include detecting a predefined event, such as detecting that the digital media item has been rented a threshold number of times, detecting that the media item is in a paused state, detecting the occurrence of a predefined user action or interaction, and/or detecting the expiration of the rental period. In response to detecting the predefined event, the method can further include sending a command to a client device to present a user interface that presents an opportunity to convert the digital media item from a rental to a purchase. The user interface can be a graphical user interface and/or an audio user interface.

In some configurations, the opportunity to purchase can include a discounted purchase price and/or an option to purchase in a different format, such as a different level of quality, a different encoding format, a different distribution format, etc. Additionally, in some cases, the opportunity to purchase can be presented on a client device other than the client device that requested the rental and/or the client device on which the media item is being used. Upon receiving an affirmative response to the conversion opportunity, the method can include updating the user account to convert the rental token to a purchase token, where the purchase token permits the use of the digital media item outside of the rental period.

A second method includes receiving a request to rent a digital media item, such as a movie or television show. The rental request can include a user account identifier and a media item identifier, as well as a variety of other information, such as level of quality, client device identifier, etc. In response to the request, the method can include updating the user account associated with the user account identifier to include a rental token. The rental token can be associated with a rental period and/or use policy for the requested digital media item. At some point, the method can include receiving a notification indicating that the digital media item is in a paused state. In response to the notification, the method can include sending a command to a client device to present a user interface that presents an opportunity to convert the digital media item from a rental to a purchase. The user interface can be a graphical user interface and/or an audio user interface. At some later time, the method can include receiving a second notification indicating that the digital media item is no longer in a paused state. In response to the notification, the method can include sending a command to the client device to disable the user interface.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary client-server configuration for converting a media item rental to a purchase;

FIG. 3 illustrates a rental conversion process;

FIG. 4 illustrates a first exemplary sequence of user accounts;

FIG. 5 illustrates a second exemplary sequence of user accounts;

FIG. 6 illustrates an exemplary graphical user interface presenting a conversion opportunity;

FIG. 7 illustrates an exemplary graphical user interface presenting a conversion opportunity including an option to purchase in a different format;

FIG. 8 illustrates an exemplary conversion opportunity presented in response to a rental request;

FIG. 9 illustrates an exemplary conversion opportunity presented in response to the occurrence of a predefined event;

FIG. 10 illustrates an exemplary conversion opportunity presented in response to receiving a notification;

FIG. 11 illustrates an exemplary user interface presenting a conversion opportunity;

FIG. 12 illustrates a first exemplary method embodiment for converting a rental to a purchase;

FIG. 13 illustrates a second exemplary method embodiment for converting a rental to a purchase; and

FIG. 14 illustrates a third exemplary method embodiment for converting a rental to a purchase.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for the conversion of a digital media item from a rental to a purchase. Using the present technology a user who has previously rented a digital media item may be convinced to convert the rental into a purchase if the opportunity is presented at the right time and/or with the correct incentive. For example, a user who has just completed watching a movie may have sufficiently enjoyed the movie such that if immediately presented with the opportunity, the user will purchase the movie. Alternatively, a user who has previously rented a movie and wants to watch it again may be convinced to purchase the movie if the previously paid rental fee is applied towards the purchase price.

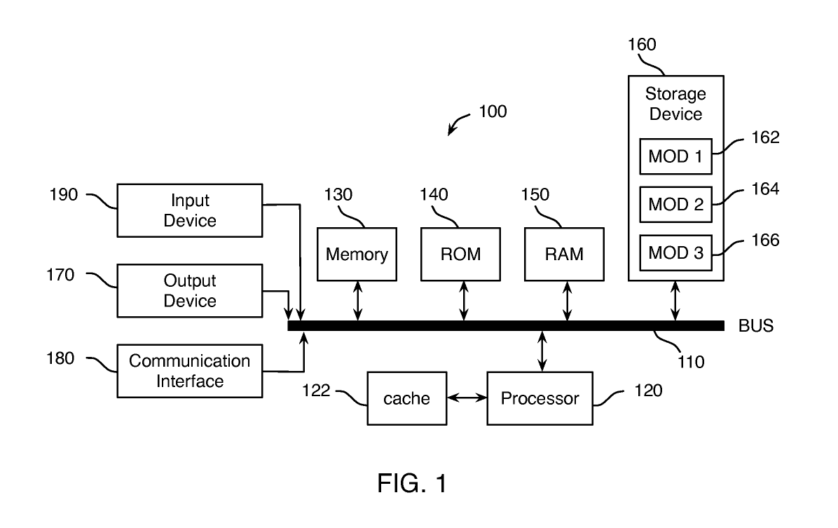

Before providing a detailed description of the conversion of a digital media item rental to a purchase, the disclosure first sets forth a discussion of a basic general purpose system or computing device in FIG. 1 that can be employed to practice the concepts disclosed herein. With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

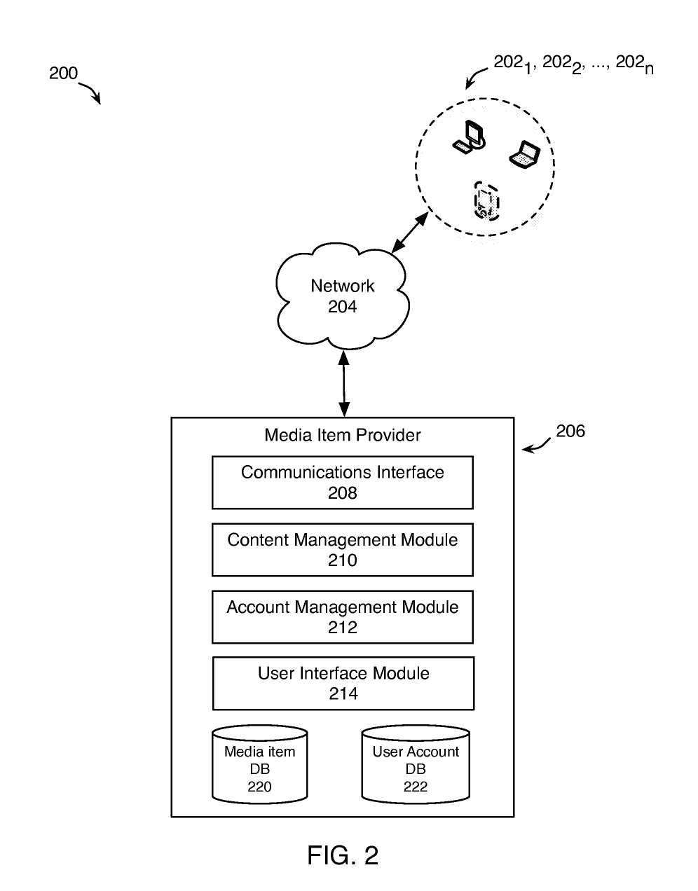

Having disclosed some components of a computing system, the disclosure now turns to FIG. 2, which illustrates an exemplary client-server configuration 200 for converting a digital media item rental to a purchase. In the exemplary client-server configuration 200, the media item provider 206 can reside on a server, such as a general-purpose computing device like system 100 in FIG. 1.

In system configuration 200, a media item provider 206 can communicate with one or more client devices 202₁, 202₂, . . . , 202ₐ (collectively “202”) connected to a network 204 by direct and/or indirect communication. The media item provider 206 can support connections from a variety of different client devices, such as desktop computers; mobile computers; handheld communications devices, e.g. mobile phones, smart phones, tablets; smart televisions; set-top boxes; and/or any other network-enabled computing devices. Furthermore, the media item provider 206 can concurrently accept connections from and interact with multiple client devices 202.

The media item provider 206 can receive a request to rent or purchase a digital media item from a client device 202. The request can include a user account identifier, a media item identifier, and whether the request is to rent or purchase. The user account identifier can be used to fetch and/or update the account information associated with the user account identifier.

The request to rent or purchase can also include other information that can vary with the configuration of the system, such as a client device identifier, level of quality, encoding format, distribution format, etc. A client device identifier can indicate which client device associated with the user account the requested media item should be sent to. For example, if a single user account is associated with multiple client devices, the media item provider 206 can receive a request from one client device and send the media item to a different client device associated with the user account. Many digital media items can be distributed in different levels of quality, e.g. standard definition and high definition. Therefore, in some cases, the media item provider 206 can receive a request to rent or purchase a media item that also includes a level of quality. Additionally, the media item provider 206 can maintain a digital media item in multiple encoding formats, e.g. MP3 and ACC. In this case, the request to rent or purchase can specify an encoding format. An advantage of digital media items is that an item can be distributed using a variety of different distribution models, e.g. download and streaming. A media item provider 206 configured to support multiple distribution models can receive a request to rent or purchase that includes a distribution model. A variety of other information can also be included in the request to rent or purchase is also possible, such as operating system type.

The media item provider 206 can contain a number of components to facilitate the conversion of a rented media item to a purchased media item. The components can include one or more databases, e.g. a media item database 220 and a user account database 222, and one or more modules for interacting with the databases and/or converting media items from rental to purchase, e.g. a communications interface 208, a content management module 210, an account management module 212, and a user interface module 214. It should be understood to one skilled in the art, that the configuration illustrated in FIG. 2 is simply one possible configuration and that other configurations with more or less components are also possible.

In the exemplary configuration 200 in FIG. 2, the media item provider 206 maintains two databases. The media item database 220 can include one or more types of digital media assets, which are available for rent and purchase through the media item provider 206. A digital media item can be any digital asset that can be rented or purchased, such as music, movies, television shows, video games, electronic books, etc. However, the types of media items available through the media item provider 206 can vary with the configuration of the system. In some cases, the media item provider 206 can offer some items that are only available to rent or only available for purchase. For example, the media item provider 206 can maintain both music and movie digital media items, but the music media items can only be purchased, not rented. In another example, the media item provider 206 can maintain a variety of movie digital media items. The media item provider 206 can offer media item one for rental only, media item two for purchase only, and media item three for rental or purchase.

As described above, media item provider 206 can maintain a digital media item in multiple formats. For example, a movie media item can be maintained in H264 and MPEG4 encoding formats. Alternatively, a video game media item can be maintained in multiple formats for execution on client devices running different operating systems. By maintaining multiple formats, the media item provider 206 can support client devices with different types of media item players, media item players that support multiple encoding formats, client devices that run a variety of operating systems, etc. In some cases, a digital media item can be maintained in only a subset of the formats supported by the media item provider 206.

The media item provider 206 can also maintain digital media items in multiple levels of quality. For example, the media item provider 206 can maintain a movie media item in standard definition and/or high definition, or even multiple high definition formats, such as 720p, 1080i, and/or 1080p. In some cases, the media item provider 206 can maintain a digital media item in only a subset of the levels of quality supported by the media item provider 206.

In some cases, a media item can be formatted to be a bundle that includes multiple formats or levels of quality. For example, a media item can be a fat or multi-architecture binary. Alternatively, a media item can include a movie in both standard definition and high definition. In this case, the media item provider 206 can send the media item to a client device and that client device can share the media item with another client device associated with the user account without the second client device needing to connect to the media item provider 206 to obtain a usable media item.

In some configurations, a media item can have associated metadata. The metadata can include a variety of information including one or more predefined points in the media item. In some cases, a predefined point can be used to trigger a conversion opportunity. A predefined point can be associated with any point in the digital media item. However, in some cases, it is advantageous to select a predefined point that is likely to maximize the possibility that a user will accept the opportunity to convert. That is, a digital media item may contain one or more points where a user is more likely to accept the opportunity to convert. For example, a movie may contain a scene that is particularly strong, emotional, and/or memorable. If the conversion opportunity is presented during or closely after that scene a user may be more likely to make a snap decision to purchase the movie. It is also possible to select a predefined point that is based on features common to all media items of a particular type, such as the start of the credits in a movie or the start of a new level in a video game.

The user account database 222 can maintain information that is customarily required to complete a digital media item rental or purchase transaction, such as a user account identifier and billing information. The user account database 222 can also include additional information, such as one or more client device identifiers and/or a rental history. In some configurations, a user can associate or authorize one or more client devices with the user's account. The association can indicate that the client device is authorized to communicate with the media item provider 206 for the purpose of renting and/or purchasing a media item, receiving and/or responding to a conversion opportunity, receiving a media item, and/or using a media item. When a client device is associated or authorized with a user's account, the user account can include a client device identifier. In some cases, the media item provider 206 can authorize a client device for a subset of the functionality. For example, the media item provider 206 can authorize a client device to use a subset of the media items. In another example, the media item provider 206 can authorize a client device to receive a rental conversion opportunity, but not receive or use the media item. Additionally, in some cases, the media item provider 206 can authorize a limited number of client devices and/or client devices of a particular type for a single user account, e.g. 10 devices or 5 set-top boxes.

The user account database 222 can also maintain a rental history for each media item a user has rented. A rental history entry can include a media item identifier, the number of times the user has rented the media item, and a token or authorization. The token can be a rental token or a purchase token. A purchase token can indicate that the user purchased the associated media item. Likewise, a rental token can indicate that the user rented the associated media item. A rental token can have an associated rental period or rental policy indicating the terms of use. For example, a rental token can have an associated rental policy specifying that the user has 30 days to begin playback, but once playback has begun, the user only has 24 hours to use the media item. Additionally, a rental token can have multiple states, such as valid and expired, to indicate whether the media item is currently authorized for use. That is, a valid rental token can indicate that the rental period has yet to expire and thus the user can still use the media item. For example, suppose the media item provider 206 is configured with a rental policy where a user has 30 days to begin playback, but once playback has begun, the user only has 24 hours to use the media item. In this example, a valid rental token can indicate that the media item rental is either within the 30-day use-begin window or the 24-hour use window. Once either has expired the system can update the rental history to reflect the change in state, i.e. the state of the rental token can be changed from valid to expired. Alternatively, the user account can indicate rental and/or purchase authorization in some way other than through the use of a token.

In some configurations, the rental history can also associate a level of quality with a media item consumed by a user. In some cases, the level of quality can be associated through the token. For example, a token can be a standard definition token or a high definition token. In this example, the media item provider 206 can have four token types: standard definition rental token, high definition rental token, standard definition purchase token, and high definition rental token. Alternatively, the system can use a different media item identifier for a media asset that is available in multiple formats or a separate level of quality identifier. In some configurations, the rental history can include additional information such as media item type; encoding format; distribution format, e.g. download or steaming; platform or operating system; etc.

The media item provider 206 can purge or delete the rental history after a specified period of time. For example, the media item provider 206 can include a default rental history period for all users, such as 1 year. Additionally, the manner in which the media item provider 206 deletes the rental history can vary depending on the configuration. In some cases, when no rental transactions for a media item have occurred within the specified rental history period, the media item provider 206 can delete the entire rental history entry for the media item. For example, if the media item provider 206 is configured with a rental history period of 1 year and a user rented a media item twice, the first rental occurring 1 year, 6 months ago, and the second occurring 1 year, 1 day ago, the media item provider 206 can delete the entire rental history for that media item from the user's account. Alternatively, the media item provider 206 can delete only the expired rental transactions that occurred outside of the rental history expiration length. For example, if the media item provider 206 is configured with a rental history period of 1 year and a user rented a media item twice, the first rental occurring 1 year, 1 day ago and the second occurring 6 months ago, the media item provider 206 can delete the first rental transaction from the user's account. Using this rental history management rule, after deletion the user's account would reflect a single rental transaction for the media item, which occurred 6 months prior.

In some cases, a user can configure the length of time that their rental history is maintained, e.g. to override a default value. For example, a user may specify that the media item provider 206 cannot maintain a rental history outside of the rental period. In another example, a user may specify that the rental history period is shorter than the default value, e.g. 6 months as opposed to a default of 1 year, or longer than the default value, e.g. 2 years as opposed to a default of 1 year.

It should be understood to one skilled in the art that the media item provider 206 can be configured with more or less databases. For example, as described above, media item provider 206 can provide a variety of different types of media items, such as music, movies, television shows, etc. Therefore, in some configurations, the media item provider 206 can maintain different media item databases for different media item types. For example, the media item provider 206 can maintain one database for music media items and another database for movies and television shows or a first database for music, a second database for movies, and a third database for television shows.

In exemplary configuration 200, the media item provider 206 maintains four modules for interacting with the databases and/or converting rented media items to purchased media items. The communications interface 208 can receive a communication from a client device 202. A received communication can be a rental and/or purchase request, a notification of the occurrence of a predefined event, and/or a response to a conversion opportunity. Upon receiving a communication from a client device 202, the communications interface 208 can pass the communication along to one or more other modules in the media item provider 206 for processing. For example, a request to rent a media item can be received by the communications interface 208 and passed to the content management module 210. Additionally, the communications interface 208 can send a communication to a client device 202. A sent communication can be a media item and/or a communication related to a conversion opportunity. For example, the communications interface 208 can send a command to a client device to present a user interface that presents an opportunity to purchase a previously rented media item.

The media item provider 206 can also maintain an account management module 212. The account management module 212 can update the user account database 222 and/or obtain rental history data. In some embodiments, the account management module 212 can update a user's rental history in response to a rental or purchase transaction or when a rented media item has expired. Additionally, when the media item provider 206 is configured to only maintain rental history data for a specified length of time, the account management module 212 can update the rental history to delete or purge expired transactions.

Additionally, the media item provider 206 can include a content management module 210 that can process a rental and/or purchase request, a notification of the occurrence of a predefined event, and/or a response to a conversion opportunity. In response to receiving a request to rent a media item, the content management module 210 can instruct the account management module 212 to update the user account in the user account database 222 and/or fetch rental history data based on the rental request. Based on the rental history, the content management module 210 can identify whether the user should be presented with a conversion opportunity. In some cases, in response to a rental request the content management module 210 can fetch the media item from the media item database 220. In response to receiving a notification of the occurrence of a predefined event, the content management module 210 can identify whether the user should be presented with a conversion opportunity. Furthermore, the content management module 210 can process a response from a client device regarding a conversion opportunity. In this case, the content management module 210 can instruct the account management module 212 to update the user account and/or fetch the media item from the media item database 220.

Finally, the media item provider 206 can include functionality that requires user interaction, e.g., rental and purchase transactions and conversion opportunities. Accordingly, a user interface (UI) can be provided for communicating with a user interface module 214 for performing such tasks. The UI for the user interface module 214 can be accessed via a client device 202 in communication with the media item provider 206. The UI and the user interface module 214 can operate in a variety of client modes, including a fat client mode, a thin client mode, or a hybrid client mode, depending on the storage and processing capabilities of the media item provider 206 and/or the client device 202. Therefore, a UI for the user interface module 214 can be implemented as a standalone application operating on a client device in some embodiments. In other embodiments, a web browser-based portal can be used to provide the UI for the user interface module 214. Any other configuration to remotely or locally access the media item provider 206 can also be used in the various embodiments.

The UI can be any type of UI that facilitates user interaction. In some cases, the UI can be a graphical user interface (GUI). Alternatively, the UI can be an audio user interface (AUI) that uses audio signals, such as speech to facilitate user interaction. The UI can also be a combination of a GUI, an AUI, and/or any other type of UI.

As described above, one aspect of the present technology is the gathering and use of digital media item rental history data. The present disclosure recognizes that the use of digital media item rental history data can be used to benefit the user. For example, a user's rental history can be used to offer the user an opportunity to purchase a digital media item in the user's rental history at a discounted price. The present disclosure further contemplates that the entities responsible for the collection and/or use of the rental data should implement and consistently use privacy policies and practices that are generally recognized as meeting or exceeding industry or government requirements for maintaining the rental history data private and secure. For example, rental history data should be collected for legitimate and reasonable uses of the entity and not shared or sold outside of those legitimate uses. Further, such collection should occur only after the informed consent of the users. Additionally, such entities should take any needed steps for safeguarding and securing access to such rental history data and ensuring that others with access to the rental history data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, rental history data. That is, the present disclosure contemplates that hardware and/or software elements can be provided to prevent or block access to such rental history data. For example, the present technology can allow users to select to “opt in” or “opt out” of participation in the collection of rental history data during registration for the service or through a preferences setting. In another example, users can specify the length of time that their rental history data is maintained. For example, a user can specify that their rental history expires after one month.

Therefore, although the present disclosure broadly covers the use of rental history data to implement one or more various disclosed embodiments, the present disclosure also contemplates that various embodiments can also be implemented using a limited rental history. That is, the various embodiments of the present technology are not rendered inoperable due to a lack of rental history data. For example, the present technology can still be used to present an opportunity for conversion from a rental to a purchase during the rental period without the need to maintain a rental history outside of the rental period.

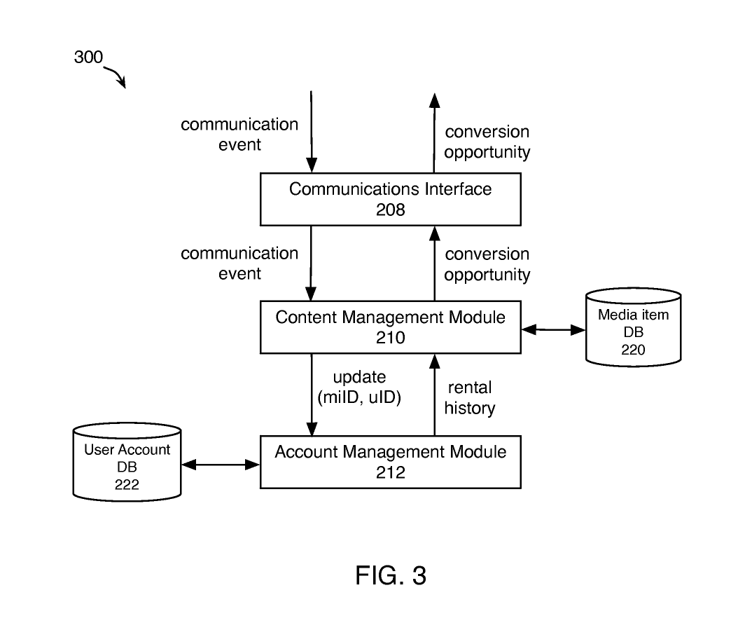

FIG. 3 illustrates an exemplary rental conversion process 300 based on the media item provider 206. In some embodiments, the communications interface 208 can receive a variety of communication events from a client device, such as client device 202. A communication event can include a rental request, a notification of an occurrence of a predefined event, and/or a conversion opportunity response. The communications interface 208 can pass the communication event to the content management module 210.

The content management module 210 can receive the communication event from the communications interface 208. The content management module 210 can perform a number of different actions depending on the type of communication event. In some embodiments, the communication event is a rental request. In response to a rental request, the content management module 210 can instruct the account management module 212 to update the user account associated with the user account identifier provided in the rental request. For example, the account management module 212 can add a new entry in the user's account that includes the media item identifier and a rental token or some other designation indicating rental authorization, rental policy, and/or the rental period. In another example, the account management module 212 can update an existing entry in the user's account to increment a rental count when the user has previously rented the media item. Furthermore, the content management module 210 can receive the rental history associated with the user account identifier and the media account identifier from the account management module 212. The content management module 210 can receive the rental history in response to a request for the rental history or in response to a request to update the user account database 222.

In some configurations, the content management module 210 can process the rental history to determine whether the user has previously rented the media item associated with the rental request. Based on the rental history, the content management module 210 can trigger a conversion opportunity. In some cases, the content management module 210 can trigger a conversion opportunity when the rental history includes at least one previous rental of the media item. However, in some cases, the system can include a threshold previous rental history value that is greater than one. For example, the system can include a previous rental history value of three in which case the content management module 210 would not trigger a conversion opportunity until the user attempted to rent a media item a fourth time.

In some embodiments, the communication is a notification of the occurrence of a predefined event. The predefined event can vary with the configuration of the system. In some cases, a predefined event can include a predefined user action or interaction, playback reaching a predefined point, and/or the expiration of the rental period. Other predefined events are also possible. In response to the notification, the content management module 210 can process the notification to determine whether to trigger a conversion opportunity. The content management module 210 can include a variety of rules to determine when to trigger a conversion opportunity. The rules can be based on the configuration of the content management module 210 and/or the predefined event.

In some cases, a predefined event is a predefined user action. A predefined user action can be any action, such as pausing, stopping, rewinding. However, in some cases, it is advantageous to select a predefined action that is likely to maximize the possibility that a user will accept the opportunity to purchase. That is, some user actions may be a stronger indication of user interest in the media item than others. For example, completing playback a predefined number of times, rewinding a predefined number of times, using the media item for a predetermined amount of time, and/or playing a particular segment a predefined number of times may indicate a strong interest in the media item Likewise, interacting with specific dynamic content within the media item, such as clicking on a hyperlink, may also indicate a strong interest in the media item. If a conversion opportunity is presented after the occurrence of one of the predefined user actions, the user may be more likely to accept the opportunity to convert the rental into a purchase. In some cases, the content management module 210 can trigger a conversion opportunity in response to receiving notification of the occurrence of a predefined user action.

In some cases, a predefined event is reaching a predefined point in the media item. In some cases, the content management module 210 can trigger a conversion opportunity in response to receiving notification that a predefined point in the media item has been reached.

In some cases, the content management module 210 can trigger or suppress a conversion opportunity after the occurrence of a combination of predefined events. For example, if the user has paused playback more than a threshold number of times, the content management module 210 can suppress the conversion opportunity for subsequently detected pause events or for a subset of the subsequently detected pause events. In another example, the content management module 210 can trigger a conversion opportunity in response to receiving a notification that a predefined point in the media item was reached, such as the credits in the movie. However, if the user previously responded to a conversion opportunity with the “ignore” response, the content management module 210 can suppress that conversion opportunity. Likewise, if the rental period expired, but the user previously selected “No, thanks,” the content management module 210 can suppress the conversion opportunity.

The content management module 210 can also use a combination of predefined events to infer a user's likelihood of responding affirmatively to a purchase opportunity. Using different inference rules, the content management module 210 can determine whether to trigger or suppress a conversion opportunity. For example, the content management module 210 can infer that a user has a strong interest in a media item if the user pauses playback within a predefined period after playback has reached a predefined point. Alternatively, the content management module 210 can infer a lack of interest upon detecting that a user has paused playback more than a predefined number of times. In this case, presenting an opportunity to convert may not be beneficial and may even degrade the user experience and thus the content management module 210 can suppress a conversion opportunity. In another example, the content management module 210 can infer a strong interest upon detecting that the user has reached the credits without pausing or stopping playback. Alternatively, the content management module 210 can infer a lack of interest upon detecting that a user failed to complete playback during the rental period. Based on the inference rules, the content management module 210 can either trigger or suppress a conversion opportunity.

In some cases, the content management module 210 can factor in the user experience when determining whether a conversion opportunity should be presented to a user. That is, if the user experience is likely to be degraded by presenting a conversion opportunity, the content management module 210 can suppress that conversion opportunity. For example, if the system is configured to display a conversion opportunity every time the user pauses playback, at some point the user is likely to get annoyed and the user experience will be degraded. In this case, the content management module 210 can trigger a conversion opportunity every n pauses or can suppress any conversion opportunity after detecting a threshold number of pauses. Likewise, if the user has previously responded to a conversion opportunity by selecting a response such as “ignore” or “no, thanks,” continuing to present the opportunity is likely to annoy the user and degrade the user experience. In this case, the content management module 210 can suppress a conversion opportunity after receiving such a response.

In some cases, the account management module 212 can store an event history of the received notifications and/or conversion opportunities in the user account to facilitate the determination of whether a conversion opportunity can be presented. For example, by storing the event history, the content management module 210 can select the timing of the conversion opportunity to maximize the likelihood of conversion and/or maximize the user experience. To make such a determination, the content management module 210 can analyze the event history to identify a conversion opportunity based on multiple predefined events.

In response to the content management module 210 triggering a conversion opportunity, the communications interface 208 can send a command to a client device to present the conversion opportunity to the user. In some cases, the conversion opportunity can include a discounted price. For example, a discount can be computed based on the number of previous rentals, such as deducting the full fee previously paid for the rental(s) or a percentage of the fee previously paid. Alternatively, a discount can be computed based on the length of time since the last rental, such as deducting a greater amount of the rental fee when the rental was more recent. Additional methods for computing a discounted fee are also possible.

In some cases, the opportunity to purchase the media item can include the opportunity to purchase the media item in a different encoding format, in a different level of quality, for a different operating system, using a different distribution model, etc. For example, if a user previously rented the media item and/or requested to rent the media item in standard definition, the opportunity to purchase can include the option to purchase the media item in high definition. Likewise, if a user previously rented in high definition, the opportunity to purchase can include the option to purchase in standard definition. It can be advantageous to present a different level of quality when it is known that most purchases of a media item occur in a particular level of quality.

In some cases, the opportunity to purchase a media item can be sent to an alternate client device associated with the user's account. For example, the notification of the occurrence of a predefined event can be received from a client device currently using the media item, such as a set-top box, and the conversion opportunity can be sent to a different client device, such as a mobile phone. This has the advantage that it is less disruptive to the user experience because it does not directly interfere with the use of the media item.

In some cases, the content management module 210 can fetch the requested media item from the media item database 220. For example, if after processing the rental history, the content management module 210 determines that a conversion opportunity should not be presented, the content management module 210 can fetch the media item to complete the rental request.

In some embodiments, the communication is a conversion opportunity response. The communications interface 208 can receive a response from a client device, such as client device 202, regarding an opportunity to purchase. The type and/or number of responses accepted can vary with the configuration of the system. In some cases, the response can be limited to accept/deny. Alternatively, the content management module 210 can process responses in between accept and reject, such as ignore or remind me later, which can be used to indicate that the user is not currently interested, but may be at a later time. Additionally, a conversion opportunity can include options to purchase in a different encoding format, in a different level of quality, for a different operating system, using a different distribution model, etc. In this case, the response can include the corresponding information.

The content management module 210 can receive the response from the communications interface 208. After receiving the response, the content management module 210 can process the response. In the case of a negative response or an in between response, such as “ignore,” the content management module 210 can take no further action. Alternatively, the content management module 210 can instruct the account management module 212 to update the user's account to reflect the user's response. For example, in the case of a negative response, the account management module 212 can update the user account to indicate that the user is not interested in receiving further conversion opportunities for the associated rental period. In some case, the content management module 210 can use this information in the future to determine whether a conversion opportunity should be presented.

In the case of an affirmative response, the content management module 210 can instruct the account management module 212 to update the user account to convert the rental to a purchase. The manner in which the account management module 212 updates the user account can vary with the configuration of the system. For example, when rental and purchase tokens are used, the account management module 212 can convert the rental token to a purchase token, where the purchase token indicates that the media item is now authorized for use outside of the original rental period. A conversion opportunity can include an opportunity to purchase the media item in a different level of quality, in a different encoding format, for a different operating system, using a different distribution model, etc. Therefore, the account management module 212 can update the user account to include any changes between the rental version and the purchase version of the media item that are maintained in the user's account. For example, if the rental was in standard definition and the purchase was in high definition, the account management module 212 can record the upgrade in the user account.

In some cases, after receiving an affirmative response to the conversion opportunity, the content management module 210 can fetch the media item from the media item database 220 for distribution to the client device. This can occur in a number of situations, such as when the media item has already expired and thus it has been deleted from the client device or when the rental and purchase versions of the media item are actually different assets. The content management module 210 can also distribute a media item to a client device when the rental was distributed using a different format than the purchase. For example, the rental was distributed via streaming and the purchase is a download or the rental was in high definition and the purchase is in standard definition. As described above, the communications interface 208 can send an opportunity to convert to an alternate client device and/or the responding client device may not have the capabilities to use the purchased media item. Therefore, in some cases, the communications interface 208 can distribute the purchased media item to a client device other than the responding client device. For example, the conversion response can be received from a mobile phone, while the media item was used on a set-top box, so the communications interface 208 can send the purchased media item to the set-top box instead of the responding mobile phone.

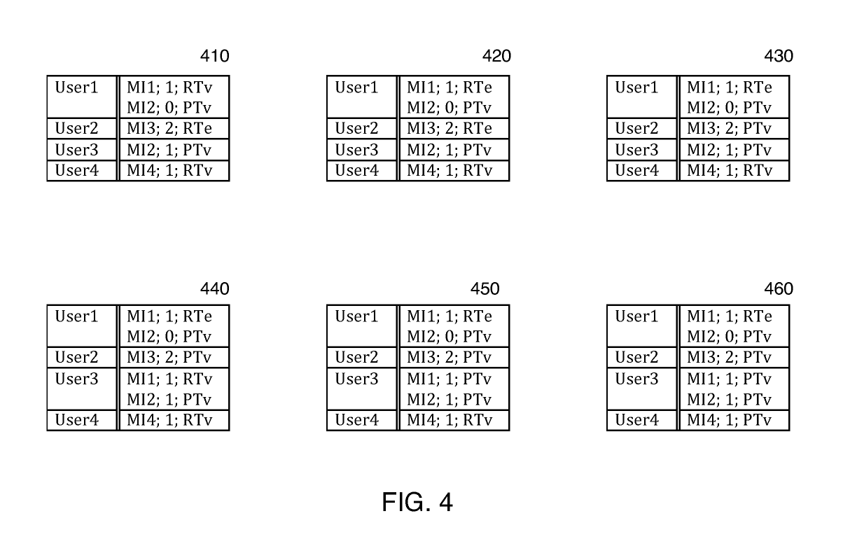

FIG. 4 illustrates a first exemplary sequence of user accounts that demonstrate how a user account can be updated in various usage scenarios. Table 410 contains four user accounts that illustrate an example user account snapshot. In table 410, User1 has rented media item MI1 one time and the rental token is currently valid. In scenario one, at some point during the rental period User1 is presented with an opportunity to convert MI1 from a rental to a purchase. In response to the conversion opportunity User1 declines to convert, therefore User1's account is updated to the state reflected in table 420, where the rental token associated with MI1 is now expired. In table 420, User2 at some point rented MI3 twice and the rental token is expired. In scenario 2, User2 has decided to rent MI3 again. When User2 attempts the rental transaction, the media item provider examines User2's rental history for MI3 and identifies that User2 has previously rented the media item, so User2 is presented with an opportunity to purchase MI3 instead of rent it again. User2 accepts the purchase opportunity, so User2's account is updated as reflected in table 430, where the token associated with media item MI3 is converted to a valid purchase token. In table 430, User3's account reflects both a rental and purchase of media item MI2. In scenario 3, User3 decides to rent media item MI1. Since, User3 has no previous rental history for media item MI1, the rental transaction completes without an offer to convert, as reflected in table 440. However, upon completion of playback, User3 is presented with the opportunity to purchase MI1. User3 accepts the offer, therefore User3's account is updated to reflect the conversion, as shown in table 450. In table 450, User4 has rented media item MI4 once and the rental token is currently valid. In scenario 4, at some point during playback, User4 is presented with an opportunity to convert media item MI4 from a rental to a purchase. User4 accepts the conversion offer, as shown in table 460, where the valid rental token is converted to a valid purchase token.

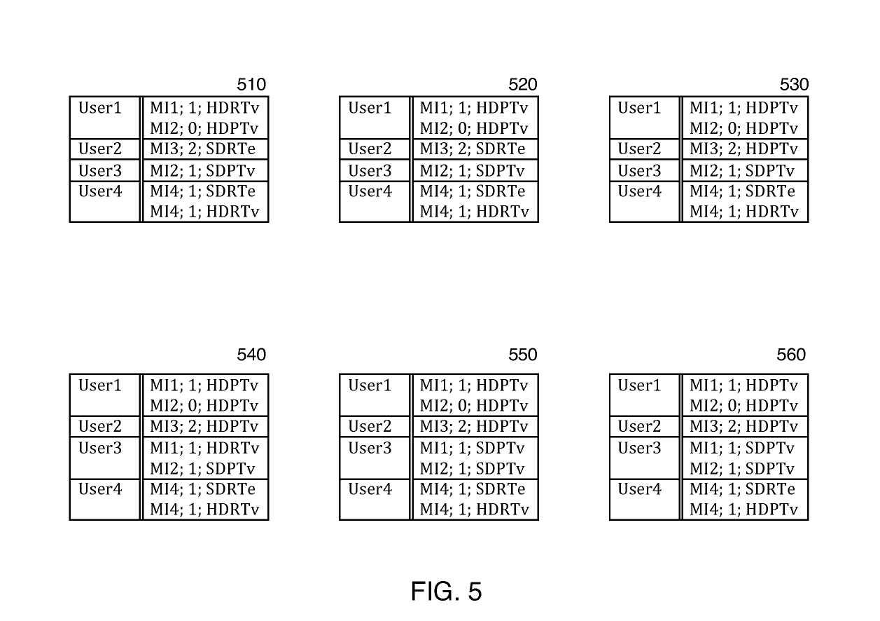

FIG. 5 illustrates a second exemplary sequence of user accounts that demonstrate how a user account can be updated in various usage scenarios. Table 510 contains four user accounts that illustrate an example user account snapshot. In table 510, User1 has rented media item MI1 one time in high definition and the high definition rental token is currently valid. In scenario one, at some point during the rental period User1 is presented with an opportunity to convert MI1 from a rental to a purchase. The opportunity to convert includes both an option to purchase in standard definition and in high definition. In response to the conversion opportunity, User1 chooses to purchase the high definition version. The high definition conversion purchase is reflected in table 520, where the valid high definition rental token is converted to a valid high definition purchase token. In table 520, User2 at some point rented MI3 twice in standard definition, but the standard definition rental token is expired. In scenario 2, User2 has decided to rent MI3 in standard definition again. When User2 attempts the rental transaction, the media item provider examines User2's rental history for MI3 and identifies that User2 has previously rented the media item so User2 is presented with an opportunity to purchase MI3 instead of rent it again. As with User1, User2 is presented with the opportunity to purchase MI3 in standard definition or high definition. User2 accepts the purchase opportunity and decides to upgrade the quality to high definition, so User2's account is updated as reflected in table 530, where the expired standard definition rental token associated with media item MI3 is converted to a valid high definition purchase token. In table 530, User3's account reflects both a rental and a purchase of media item MI2 in standard definition. In scenario 3, User3 decides to rent media item MI1 in high definition. Since, User3 has no previous rental history for media item MI1, the rental transaction completes without an offer to convert, as reflected in table 540. However, during playback, User3 is presented with the opportunity to purchase MI1 in both standard definition and high definition. User3 accepts the offer, but instead of purchasing in high definition, User 3 converts to the lower quality standard definition. After the conversion transaction, User3's account is updated as shown in table 550, where the high definition rental token is converted to a standard definition purchase token. In table 550, User4 has rented media item MI4 once in standard definition and once in high definition. Currently, only the high definition rental token is valid. In scenario 4, at some point during the rental period, User4 is presented with an opportunity to convert media item MI4 from a rental to a purchase in either standard definition or high definition. User4 accepts the conversion offer and chooses high definition, as shown in table 560, where the valid high definition rental token is converted to a valid high definition purchase token.

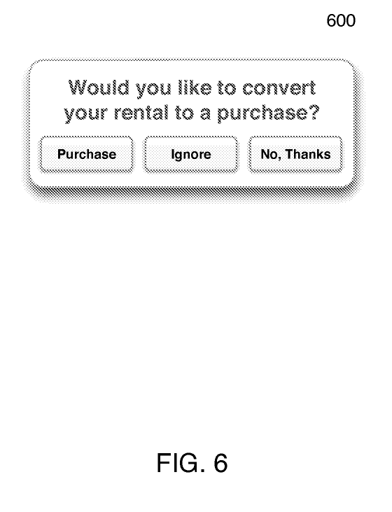

FIGS. 6-11 illustrate exemplary graphical user interfaces that can be displayed on a client device to present an opportunity to convert a rental into a purchase. FIG. 6 illustrates a basic GUI 600 that can be displayed on a client device to present an opportunity to purchase. The client device can be a device from which the rental request was made, a device on which the media item is being used, and/or a different client device associated with the user account. Additionally, GUI 600 can be presented on multiple client devices. GUI 600 can be presented in response to any conversion opportunity. For example, GUI 600 can be presented after the user attempts to re-rent a previously rented media item. In an alternative example, GUI 600 can be presented in response to the occurrence of a predefined event, such as reaching a predefined point in the playback or the occurrence of a predefined user action. Furthermore, GUI 600 can be displayed on any client device type that supports a graphical user interface.

Exemplary GUI 600 contains three buttons: “Purchase,” “Ignore,” and “No, Thanks.” In GUI 600, the button labeled “Ignore” indicates that the user is not currently interested, but that the user can be presented with a purchase opportunity at a later time. The button labeled “No, Thanks” indicates that the user is not interested and the user should not be asked again during the rental period or should not be asked again for the media item. However, one skilled in the art will recognize that a GUI with more or less buttons is also possible. For example, a GUI with just a “Purchase” and a “No, Thanks” button can also be used. Alternatively, a GUI with additional buttons, such as different purchase options, can also be used. Additionally, the text of the conversion opportunity can vary. For example, the conversion opportunity can be customized for the user and/or the media item.

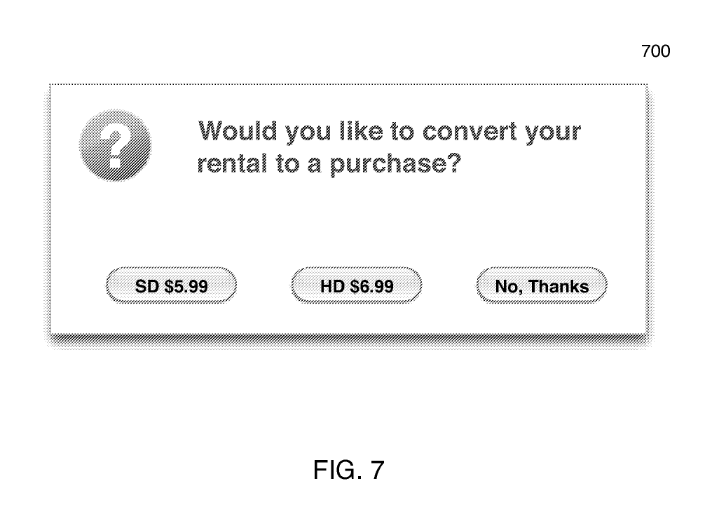

FIG. 7 illustrates an exemplary conversion opportunity GUI 700 that includes the option to purchase the media item in different formats. In GUI 700, the user is presented with the opportunity to convert the media item rental to a purchase in either standard definition or high definition. As described above, a conversion opportunity can include an opportunity to purchase the media item in a different level of quality, in a different encoding format, for a different operating system, using a different distribution model, etc. Therefore, the conversion opportunity GUI, such as GUI 700, can be customized based on the different options available.

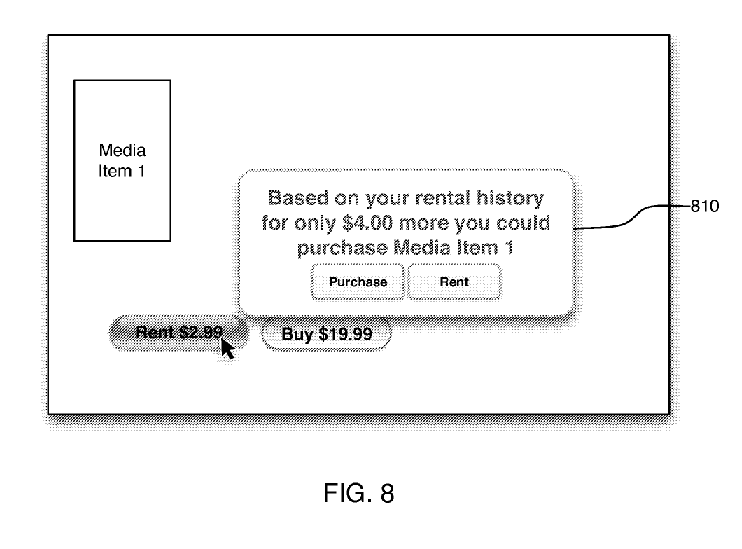

FIG. 8 illustrates an exemplary usage scenario in which a conversion opportunity is presented in response to a user requesting to rent a media item. In this usage scenario, the media item provider can receive a rental request from a client device. In response to the request, the media item provider can check the rental history in the user's account. If the user has previously rented the media item a threshold number of times, the media item provider can send a command to the client device to display a conversion opportunity. In some cases, as illustrated in conversion opportunity GUI 810, the conversion opportunity can include a discounted purchase price. The discounted purchase price can be based on the rental history. Alternatively, in some cases, the media item provider can initially display the discounted purchase price instead of the original purchase price. For example, in FIG. 8, the buy button could display the discounted purchase price. In this case, the media item provider would not need to display the additional conversion opportunity GUI 810.

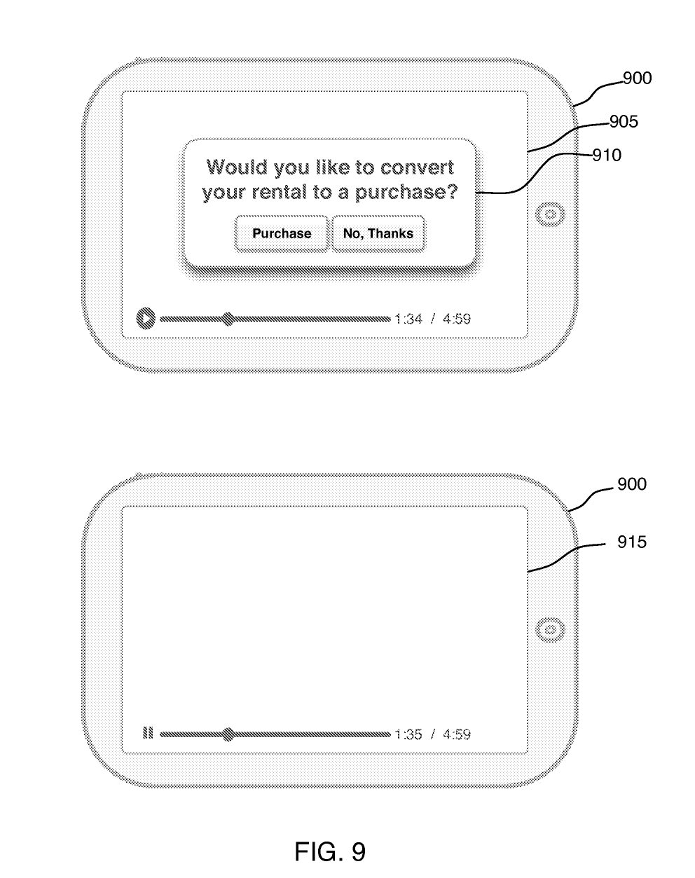

FIG. 9 illustrates an exemplary usage scenario in which the purchase opportunity GUI 910 is displayed on the display 905 of client device 900 in response to a predefined event, such as a pause event during playback. GUI 910 can be removed from the display in response to a click event, such as the user clicking “Purchase” or “No, Thanks,” or GUI 910 can be removed in response to some other predefined user action, such as resumption of playback as reflected on display 915 of client device 900. In the illustrated usage scenario, the media item provider can receive notification of a pause event from client device 900. In response, the media item provider can send a command to client device 900 to display a user interface, such as GUI 910, which presents a conversion opportunity to the user. The media item player can then receive a conversion opportunity response in the form of a predefined user action, in this case playback resuming. That is, a conversion opportunity response does not need to be an explicit response. Instead, the conversion opportunity response can be an implicit response based on some action other than a click of a button in GUI 910. The media item provider can then send a command to client device 900 to remove GUI 910 as reflected in display 915 where playback is resumed and the GUI is no longer displayed.

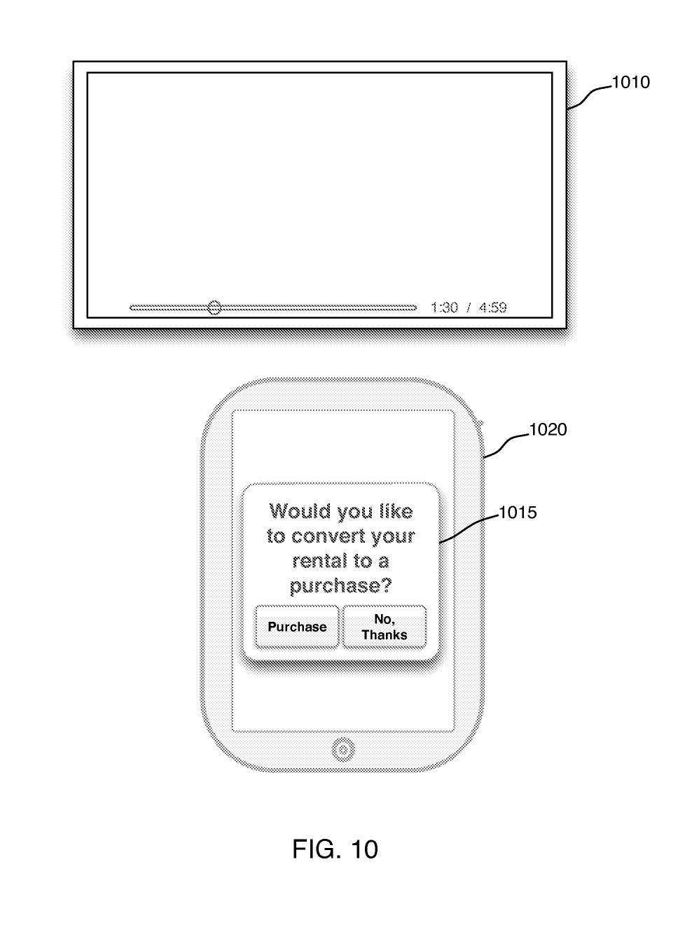

FIG. 10 illustrates an exemplary usage scenario in which the purchase opportunity GUI 1015 is displayed on client device 1020 in response to receiving a notification of a predefined event or a notification of the detection of a conversion opportunity from client device 1010 associated with a user account. For example, the media item provider can receive a notification from client device 1010 that playback has reached a predefined point, which can be determined using associated metadata. In response to the notification, the media item provider can send a conversion opportunity to one or more other client devices associated with the user account. The one or more other client devices can be client devices of any type, including a client device that is not capable of using the media item. By sending the command to display a conversion opportunity to a client device other than client device 1010, the presentation of the purchase opportunity can have a more limited impact on the user experience because it not interrupting use of the media item on client device 1010.

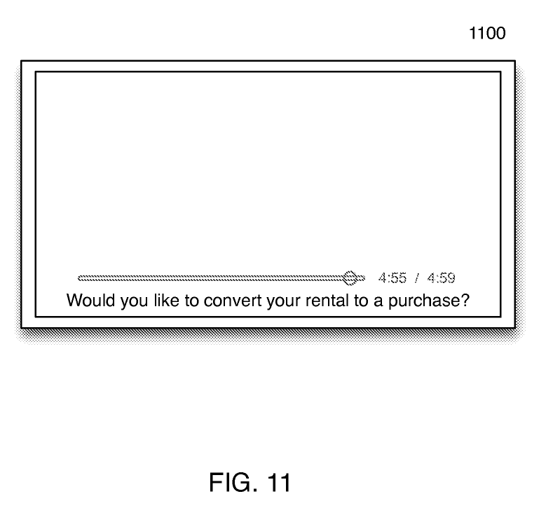

FIG. 11 illustrates another exemplary usage scenario in which the purchase opportunity is presented at the bottom of the display on client device 1100. In this usage scenario, the media item provider can receive a notification of the occurrence of a predefined event or a notification of the detection of a conversion opportunity from client device 1100. In response to the notification, the media item provider can send a command to client device 1100 to display the conversion opportunity. In some cases, the conversion opportunity can be presented during use with little impact on the user experience. For example, if a portion of the display on client device 1100, such as the bottom, is reserved for communication with the user. Alternatively, the conversion opportunity can be presented other times such as when the media item is paused or on a UI that permits the user to interact with their rented and/or purchased media items. In addition to displaying the conversion opportunity on the display of client device 1100, the conversion opportunity can be presented to the user through an audio UI. For example, the conversion opportunity can be spoken to the user. In some cases, the user's response can be received via an audio UI. The conversion opportunity can also be presented in a different area of the display, such as the top. Additionally, if the client device is capable of different orientations, the placement of the conversion opportunity can be dictated by the orientation of the client device.

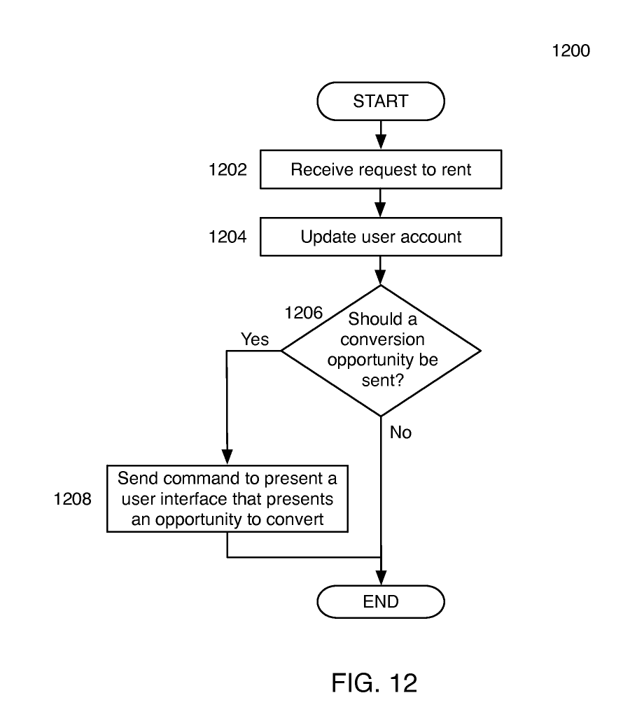

FIG. 12 is a flowchart illustrating an exemplary method 1200 for converting a digital media item from a rental to a purchase. For the sake of clarity, this method is discussed in terms of an exemplary media item provider such as is show in FIG. 2. Although specific steps are shown in FIG. 12, in other embodiments a method can have more or less steps than shown. The rental to purchase conversion process begins at step 1202 where the method includes receiving a request to rent a digital media item. The rental request can include a user account identifier and a media item identifier, as well as a variety of additional information, such as client device identifier, level of quality, encoding type, distribution format, etc.

After receiving the request, the method can include updating the user account associated with the account identifier (1204). For example, the user account can be updated to include a new entry for the media item identifier and a rental token or some other designation indicating rental authorization, rental policy, and/or the rental period. In another example, if the user had previously rented the media item, the method can update an exiting entry for the media item to increment a rental count.

At some point, the method can include determining whether a conversion opportunity should be presented to the user (1206). The method can include triggering a conversion opportunity based on the occurrence of a predefined event. A predefined event can be detecting that the user has rented the media item a threshold number of times and/or receiving a notification of the occurrence of a predefined event on a client device, e.g. occurrence of a predefined user action or interaction, playback reaching a predefined point, and/or the expiration of the rental period.

In some cases, the method will not include triggering a conversion opportunity based only on receiving a notification of the occurrence of a predefined event on a client device. That is, the method can instead include analyzing a variety of information upon receiving the notification. For example, in some configurations, the method can include triggering or suppressing a conversion opportunity after the occurrence of a combination of predefined events. In some cases, the method can include factoring in the user experience to determine whether a conversion opportunity should be presented to a user. That is, if the method including determining that the user experience is likely to be degraded by the presentation of a conversion opportunity, the method can also include suppressing the conversion opportunity.

In response to determining that a predefined event has occurred, the method can include sending a command to a client device to present a user interface that presents an opportunity to convert the media item from a rental to a purchase (1208). In some cases, the method can include a discounted purchase price in the opportunity to purchase the media item. Additionally, in some cases, the opportunity to purchase the media item can include the opportunity to purchase the media item in a different encoding format, in a different level of quality, for a different operating system, using a different distribution model, etc. The opportunity to purchase the media item can be presented to the user through a user interface presented on the client device. In some cases, the user interface can be a graphical user interface and/or an audio user interface.

In some cases, the method can include sending the opportunity to purchase a media item to an alternate client device associated with the user's account. For example, the method can include receiving the notification of the occurrence of a predefined event from a client device currently using the media item, such as a set-top box, and the method can include sending the conversion opportunity to a different client device, such as a mobile phone. This has the advantage that it is less disruptive to the user experience because it does not directly interfere with the use of the media item.

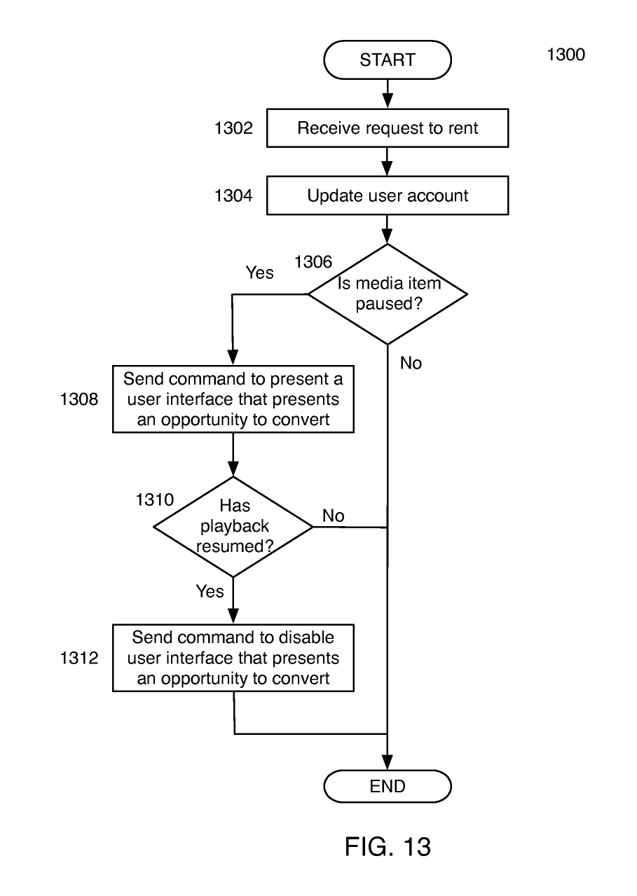

FIG. 13 is a flowchart illustrating an exemplary method 1300 for converting a digital media item from a rental to a purchase. For the sake of clarity, this method is discussed in terms of an exemplary media item provider such as is show in FIG. 2. Although specific steps are shown in FIG. 13, in other embodiments a method can have more or less steps than shown. The rental to purchase conversion process begins at step 1302 where the method includes receiving a request from a client device to rent a digital media item. The rental request can include a user account identifier and a media item identifier, as well as a variety of additional information, such as client device identifier, level of quality, encoding type, distribution format, etc.

After receiving the request, the method can include updating the user account associated with the account identifier (1304). For example, the method can include updating the user account to include a new entry for the media item identifier and a rental token or some other designation indicating rental authorization, rental policy, and/or the rental period. In another example, the method can include updating an exiting entry for the media item to increment a rental count if the user had previously rented the media item.

At some point during the rental period of the media item, the method can include determining whether the media item is in a paused state (1306). In some cases, the method can include determining that the media item is in a paused state through an explicit notification from a client device. Alternatively, if the media item is streamed to the client device, the method can include determining that the item is in a paused state because there has been a pause in the streaming. In some cases, the method can include receiving the notification that the media item is in a paused state from a client device other than the client device from which the rental request was received.

In response to determining that the media item is in a paused state, the method can include sending a command to the client device on which the media item is being used to present a user interface that presents an opportunity to convert the media item from a rental to a purchase (1308). In some cases, the method can include a discounted purchase price in the opportunity to purchase the media item. Additionally, in some cases, the opportunity to purchase the media item can include the opportunity to purchase the media item in a different encoding format, in a different level of quality, for a different operating system, using a different distribution model, etc. The opportunity to purchase the media item can be presented to the user through a user interface presented on the client device. In some cases, the user interface can be a graphical user interface and/or an audio user interface.

At some point after detecting that the media item is in a paused state, the method can include determining whether playback has resumed (1310). In some cases, the method can include determining that playback has resumed through an explicit notification from a client device. Alternatively, if the media item is streamed to the client device, the method can include determining that playback has resumed because streaming has resumed. In response to determining that playback has resumed, the method can include sending a command to the client device on which the media item is being used to remove the user interface presenting the opportunity to convert (1312).

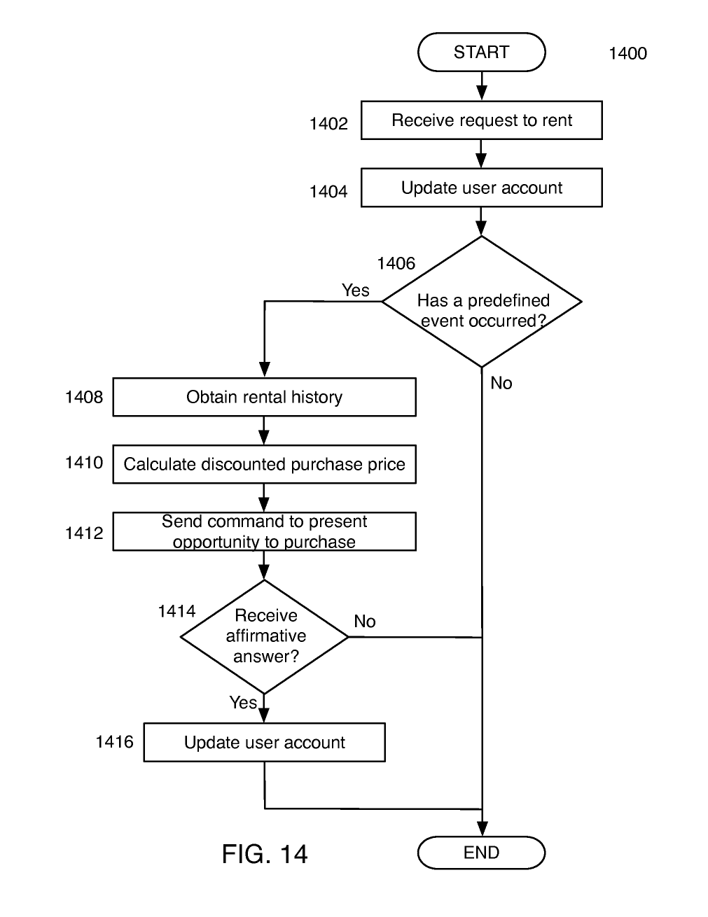

FIG. 14 is a flowchart illustrating an exemplary method 1400 for converting a digital media item from a rental to a purchase. For the sake of clarity, this method is discussed in terms of an exemplary media item provider such as is show in FIG. 2. Although specific steps are shown in FIG. 14, in other embodiments a method can have more or less steps than shown. The rental to purchase conversion process begins at step 1402 where the method includes receiving a request from a client device to rent a digital media item. The rental request can include a user account identifier and a media item identifier, as well as a variety of additional information, such as client device identifier, level of quality, encoding type, distribution format, etc.

After receiving the request, the method can include updating the user account associated with the account identifier (1404). For example, the method can include updating the user account to include a new entry for the media item identifier and a rental token or some other designation indicating rental authorization, rental policy, and/or the rental period. In another example, the method can include updating an exiting entry for the media item to increment a rental count if the user had previously rented the media item.

At some point, the method can include determining whether a conversion opportunity should be presented to the user (1406). The method can include triggering a conversion a conversion opportunity in response to the occurrence of a predefined event. A predefined event can be detecting that the user has rented the media item a threshold number of times and/or receiving a notification of the occurrence of a predefined event on a client device, e.g. occurrence of a predefined user action or interaction, playback reaching a predefined point, and/or the expiration of the rental period.

In some cases, the method will not include triggering a conversion opportunity in response to only receiving a notification of the occurrence of a predefined event on a client device. That is, the method can include analyzing a variety of information upon receiving a notification. For example, in some configurations, the method can include triggering or suppressing a conversion opportunity after the occurrence of a combination of predefined events. In some cases, the method can include factoring in the user experience to determine whether a conversion opportunity should be presented to a user. That is, if the user experience is likely to be degraded by the presentation of a conversion opportunity, the method can include suppressing the conversion opportunity.

In response to determining that a predefined event has occurred, the method can include obtaining the rental history for the media item from the user's account (1408). Based on the rental history, the method can include calculating a discounted purchase price (1410). For example, the method can include computing the discount based on the number of previous rentals, such as deducting the full fee previously paid for the rental(s) or a percentage of the fee previously paid. Alternatively, the method can include computing the discount based on the length of time since the last rental, such as deducting a greater amount of the rental fee when the rental was more recent. Additional methods for computing a discounted fee are also possible.

After calculating the discounted purchase price, the method can include sending a command to a client device to present a user interface that presents an opportunity to convert the media item from a rental to a purchase (1412), where the opportunity includes the discounted purchase price. In some cases, the opportunity to purchase the media item can also include the opportunity to purchase the media item in a different encoding format, in a different level of quality, for a different operating system, using a different distribution model, etc. The opportunity to purchase the media item can be presented to the user through a user interface presented on the client device. In some cases, the user interface can be a graphical user interface and/or an audio user interface.

In some cases, the method can include sending the opportunity to purchase a media item to an alternate client device associated with the user account. For example, the notification of the occurrence of a predefined event can be received from a client device currently using the media item, such as a set-top box, and the method can send the conversion opportunity to a different client device, such as a mobile phone.

In some embodiments, the method can include receiving a response from a client device regarding an opportunity to purchase (1414). The type and/or number of responses accepted can vary. In some cases, the response can be limited to accept/deny. Alternatively, the method can include accepting responses in between accept and reject, such as ignore or remind me later, which can be used to indicate that the user is not currently interested, but may be at a later time. Additionally, a conversion opportunity can include options to purchase in a different encoding format, in a different level of quality, for a different operating system, using a different distribution model, etc. In this case, the response can include the corresponding information. However, in some cases, the method can include updating the user's account to reflect the response. For example, in the case of a negative response, the method can include updating the account to indicate that the user is not interested in receiving further conversion opportunities for the associated rental period. As described above, the method can include using this information in the future to determine whether a conversion opportunity should be presented.

In the case of an affirmative response, the method can include updating the user account to convert the rental to a purchase (1416). The manner in which the account is updated can vary. For example, when rental and purchase tokens are used, the method can include converting the rental token to a purchase token, where the purchase token indicates that the media item is now authorized for use outside of the original rental period. A conversion opportunity can include an opportunity to purchase the media item in a different level of quality, in a different encoding format, for a different operating system, using a different distribution model, etc. The method can include updating the account to show any changes between the rental version and the purchase version of the media item that are maintained in the user's account. For example, if the rental was in standard definition and the purchase was in high definition, this upgrade can be recorded in the user account.

In some cases, after receiving an affirmative response to the conversion opportunity, the method can include distributing the media item to a client device associated with the account. This can occur in a number of situations, such as when the media item has already expired and thus it has been deleted from the client device or when the rental and purchase versions of the media item are actually different assets. Distribution of a media item to a client device can also be required when the purchase is in a different format from the rental. For example, the rental was distributed via streaming and the purchase is a download or the rental was in high definition and the purchase is in standard definition. As described above, the method can include sending an opportunity to convert to an alternate client. The responding client may not have the capabilities to use the purchased media item. Therefore, in some cases, the method can include distributing the purchased media item to a client device other than the responding client device. For example, the conversion response can be received from a mobile phone, while the media item was used on a set-top box, so the purchased media item can be sent to the set-top box instead of the responding mobile phone.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer implemented method for converting a digital media item rental into a purchase, the method comprising:
receiving, on a server, a request to rent a digital media item, the request including a user account identifier, the request received from a first client device;
updating, via a processor, a user account associated with the user account identifier to include a rental token, the rental token allowing use of the digital media item during a rental period;
detecting a predefined event; and
in response to the predefined event, sending a command to a client device to present a user interface that presents an opportunity to convert the digital media item from a rental to a purchase.

2. The computer implemented method of claim 1, further comprising:
receiving an affirmative answer in response to the opportunity to convert; and
updating the user account to convert the rental token to a purchase token, the purchase token allowing use of the digital media item outside of the rental period.

3. The computer implemented method of claim 1, wherein the user interface is at least one of a graphical user interface or an audio user interface.

4. The computer implemented method of claim 1, wherein sending the command to a client device includes sending the command to a second client device associated with the user account identifier.

5. The computer implemented method of claim 1, wherein sending the command to a client device to present a user interface that presents an opportunity to convert further comprises:
identifying based on the user account identifier a number of times the digital media item has been rented;
calculating a scaled purchase price responsive to the number of times the digital media item has been rented; and
sending the command to the client device to present a user interface that presents an opportunity to convert, the opportunity including the scaled purchase price.

6. The computer implemented method of claim 1, wherein the predefined event includes identifying based on the user account identifier that the digital media item has previously been rented a threshold number of times.

7. The computer implemented method of claim 1, wherein detecting a predefined event further comprises:
sending the digital media item to the first client device; and
receiving a notification that a predefined interaction event has occurred during use of the digital media item.

8. The computer implemented method of claim 1, wherein the request further includes a first level of quality and further wherein the rental token is associated with the first level of quality, and further wherein the opportunity to convert includes an option to convert the media item to a second level of quality.

9. The computer implemented method of claim 8, further comprising:
receiving an affirmative answer in response to the opportunity to convert; and
updating the user account to convert the rental token associated with the first level of quality to a purchase token associated with the second level of quality, the purchase token allowing use of the digital media item in the second level of quality outside of the rental period.

10. A system for converting a digital media item rental into a purchase, the system comprising:
a server;
the server maintaining a database including a plurality of user accounts;
a first module configured to control the server to receive a request to rent a digital media item, the request including a user account identifier, the request received from a first client device;
a second module configured to control the server to update a user account associated with the user account identifier to indicate a rental authorization, the rental authorization comprising a right to use the digital media item during a specified rental period;
a third module configured to control the server to detect a triggering event; and
a fourth module configured to control the server to send, in response to the triggering event, a command to a client device to present a user interface that presents an opportunity to purchase the digital media item.

11. The system of claim 10, further comprising:
a fifth module configured to control the server to receive an affirmative response to the opportunity to purchase; and
a sixth module configured to control the server to update the user account to indicate a purchase authorization, the purchase authorization comprising a right to use the digital media item outside of the specified rental period.

12. The system of claim 10, wherein sending a command to present a user interface that presents an opportunity to purchase the media item further comprises:
a fifth module configured to control the server to identify, based on the user account identifier, a number of times the digital media item has been rented;
a sixth module configured to control the server to calculate a discounted purchase price responsive to the number of times the digital media item has been rented; and
a seventh module configured to control the server to present the opportunity to purchase the digital media item, the opportunity including the discounted purchase price.

13. The system of claim 10, wherein detecting a triggering event further comprises receiving a subsequent request to rent the digital media item.

14. The system of claim 10, wherein detecting a triggering event further comprises:
a fifth module configured to control the server to send the digital media item to the first client device, the media item authorized for playback during a rental period; and
a sixth module configured to control the server to receive a notification that a predefined event has occurred during playback.

15. The system of claim 14, wherein the predefined event includes at least one of pausing the digital media item, reaching a predefined point in the digital media item, and the expiration of a rental period.

16. The system of claim 15, wherein the predefined point is a start of a credits section.

17. The system of claim 10, wherein sending the command to a client device includes sending the command to a second client device associated with the user account identifier.

18. A non-transitory computer-readable storage medium storing instructions which, when executed by a computing device, causes the computing device to convert a digital media item rental to a purchase, the instructions comprising:
receiving a request to rent a digital media item from a first client device, the request including a user account identifier and a level of quality;
updating a user account associated with the user account identifier to include a rental authorization, the rental authorization indicating a rental period for the media item;
transmitting the digital media item to the first client device, the digital media item authorized for playback during the rental period; and
sending a command to a client device to present a user interface that presents an opportunity to purchase the requested digital media item, the opportunity to purchase triggered by an occurrence of a conversion opportunity event.

19. The non-transitory computer-readable storage medium of claim 18, wherein transmitting the digital media item further comprises streaming the digital media item to the first client device.

20. The non-transitory computer-readable storage medium of claim 18, wherein transmitting the digital media item further comprises downloading the digital media item to the first client device.

21. The non-transitory computer-readable storage medium of claim 18, wherein the opportunity to purchase includes a discounted purchase price.

22. The non-transitory computer-readable storage medium of claim 18, the instructions further comprising:
receiving from a second client device, responsive to the opportunity to purchase, a request to purchase the media item;
updating the user account to convert the rental authorization to a purchase authorization; and
sending the purchased media item to the first client device, the purchased digital media item authorized for playback outside of the rental period.

23. The non-transitory computer-readable storage medium of claim 18, wherein the conversion opportunity event further comprises receiving notification of an occurrence of a predefined interaction event.

24. The non-transitory computer-readable storage medium of claim 18, wherein the conversion opportunity event further comprises reaching a threshold number of previous rentals of the digital media item.

25. A computer implemented method for converting a digital media item rental into a purchase, the method comprising:
receiving, on a server, a request to rent a digital media item, the request including a user account identifier, the request received from a client device;
updating, via a processor, a user account associated with the user account identifier to include a rental token, the rental token allowing use of the digital media item during a rental period;
receiving a first notification, the first notification indicating the digital media item is in a paused state;
in response to the first notification, sending a first command to the client device to present a user interface that presents an opportunity to convert the digital media item from a rental to a purchase;
receiving a second notification, the second notification indicating the digital media item is in a play state; and
in response to the second notification, sending a second command to the client device to disable the user interface.
